(19) United States
(12) Patent Application Publication
(10) Pub. No.: US 2014/0362004 A1
(43) Pub. Date: Dec. 11, 2014

(54) INPUT PROCESSING APPARATUS, INFORMATION PROCESSING APPARATUS, INFORMATION PROCESSING SYSTEM, INPUT PROCESSING METHOD, INFORMATION PROCESSING METHOD, INPUT PROCESSING PROGRAM AND INFORMATION PROCESSING PROGRAM

(71) Applicant: Panasonic Corporation, Osaka (JP)

(72) Inventors: Yuji DOI, Kanagawa (JP); Natsuki USHIGOME, Kanagawa (JP); Yutaka KOBAYASHI, Tokyo (JP)

(73) Assignee: PANASONIC CORPORATION, Osaka (JP)

(21) Appl. No.: 14/264,542

(22) Filed: Apr. 29, 2014

(30) Foreign Application Priority Data
Jun. 11, 2013 (JP) 2013-122796

(51) Int. Cl. G06F 3/041

(52) U.S. Cl. CPC G06F 3/041
USPC 345/173

(57) ABSTRACT

An input processing apparatus for communicating with an information processing apparatus, includes an input detection section configured to detect a proximity and a contact of an object as input, an event type distinguishing section configured to distinguish a type of an input event on the basis of coordinates of the input detected by the input detection section, a mode information acquiring section configured to acquire information of a processing mode for an application to be processed by the information processing apparatus, and a transmission section configured to transmit data including the information of the type of the event distinguished by the event type distinguishing section and the information of the processing mode acquired by the mode information acquiring section to the information processing apparatus.

The present invention relates to an input processing apparatus, an information processing apparatus, an information processing system, an input processing method, an information processing method, an input processing program and an information processing program. More particularly, the present invention relates to, for example, an input processing apparatus having a touch panel capable of detecting the proximity and contact of an object as input.

Delivering presentation to viewers using, for example, a PC (personal computer) and an indicator (for example, a laser pointer) is generally performed. In the case that presentation is delivered, for example, an indicator for presentation described below can be used (for example, refer to JP-A-2002-351609).

This indicator for presentation has an operation switch section and a pointer switch, and the operation switch section is provided with a plurality of buttons. The indicator for presentation generates a code corresponding to the function of an application depending on an operated button, modulates a carrier, for example, an electromagnetic wave, depending on the generated code, and receives the modulated carrier. Upon receiving the carrier transmitted from the indicator for presentation, the personal computer executes the function of the application on the basis of the carrier and displays the image corresponding to the application on a screen from a projector. Furthermore, when the pointer switch was pressed, the indicator for presentation emits, for example, an infrared laser beam from its tip end portion on the side of the screen pointing direction, thereby pointing the image of the application magnified and projected on the screen.

In addition, in the case that a portable terminal is connected to a projector to perform presentation, a touch panel type electronic apparatus is known that is used to project and display a touch operation position depending on the display content of an object to be operated (for example, refer to JP-A-2013-073595).

This touch panel type electronic apparatus, that is, an electronic apparatus having a display section with a touch panel, is equipped with touch position detecting means, means for judging an object to be touched, touch position synthesizing means and display data outputting means. The touch position detecting means detects the position at which a touch operation was performed. The means for judging an object to be touched judges the display content being displayed on the display section and corresponding to the position of the touch operation when the position of the touch operation was detected by the touch position detecting means. The touch position synthesizing means synthesizes a sign indicating the touch operation position detected by the touch position detecting means with the display data being displayed on the display section in a display form depending on the display content judged by the means for judging an object to be touched. The display data outputting means outputs the display data being displayed on the display section to a projector.

However, with the technologies described in JP-A-2002-351609 and JP-A-2013-073595, the operability of apparatuses for use in presentation is insufficient, and it is likely that the quality of presentation is degraded.

### SUMMARY

In consideration of the above-mentioned circumstances, the present invention provides an input processing apparatus, an information processing apparatus, an information processing system, an input processing method, an information processing method, an input processing program and an information processing program capable of achieving effective and impressive presentation.

The input processing apparatus according to the present invention is an input processing apparatus for communicating with an information processing apparatus and is equipped with an input detection section for detecting the proximity and contact of an object as input; an event type distinguishing section for distinguishing the type of an input event on the basis of the coordinates of the input detected by the input detection section; a mode information acquiring section for acquiring the information of the processing mode for the application to be processed by the information processing apparatus; and a transmission section for transmitting data including the information of the type of the event distinguished by the event type distinguishing section and the information of the processing mode acquired by the mode information acquiring section to the information processing apparatus.

Besides, the information processing apparatus according to the present invention is an information processing apparatus for communicating with an input processing apparatus and is equipped with an application processing section for processing an application for realizing a predetermined function; a receiving section for receiving data including the information of the type of the event input to the input processing apparatus and the information of the processing mode of the application to be processed by the application processing section from the input processing apparatus; and a display control section for displaying the screen of the application processed by the application processing section via a display apparatus, wherein, in the case that the information of the type of the event is proximity detection information indicating that the proximity to the input detection section of the input processing apparatus was detected, the application processing section adds the information indicating the processing of the application in the processing mode to the screen of the application, and in the case that the information of the type of the event is contact detection information indicating that the contact to the input detection section of the input processing apparatus was detected, the application processing section processes the application depending on the processing mode.

Additionally, the information processing system according to the present invention is an information processing system for making communication between an input processing apparatus and an information processing apparatus, wherein the input processing apparatus is equipped with an input detection section for detecting the proximity and contact of an object as input; an event type distinguishing section for distinguishing the type of an input event on the basis of the coordinates of the input detected by the input detection section; a mode information acquiring section for acquiring the information of the processing mode for the application to be processed by the information processing apparatus; a transmission section for transmitting data including the information of the type of the event distinguished by the event type distinguishing section and the information of the processing mode acquired by the mode information acquiring section to the information processing apparatus, and the information processing apparatus is equipped with an application processing section for processing an application for realizing predetermined functions; a receiving section for receiving the data from the input processing apparatus; and a display control section for displaying the screen of the application processed by the application processing section via a display apparatus, wherein, in the case that the information of the type of the event is proximity detection information indicating that the proximity to the input detection section was detected, the application processing section adds the information indicating the processing of the application in the processing mode to the screen of the application, and in the case that the information of the type of the event is contact detection information indicating that the contact to the input detection section was detected, the application processing section processes the application depending on the processing mode.

The input processing method according to the present invention is an input processing method in an input processing apparatus for communicating with an information processing apparatus and has the step of distinguishing the type of an input event on the basis of the coordinates of the input detected by an input detection section for detecting the proximity and contact of an object as input; the step of acquiring the information of the processing mode for an application to be processed by the information processing apparatus; and the step of transmitting data including the information of the type of the distinguished event and the information of the acquired processing mode to the information processing apparatus.

Furthermore, a first information processing method according to the present invention is an information processing method in an information processing apparatus for communicating with an input processing apparatus and has the application processing step of processing an application for realizing predetermined functions; the step of receiving data including the information of the type of the event input to the input processing apparatus and the information of the processing mode of the application to be processed from the input processing apparatus; and the step of displaying the screen of the processed application via a display apparatus, wherein, in the application processing step, in the case that the information of the type of the event is proximity detection information indicating that the proximity to the input detection section of the input processing apparatus was detected, the information indicating the processing of the application in the processing mode is added to the screen of the application, and in the case that the information of the type of the event is contact detection information indicating that the contact to the input detection section of the input processing apparatus was detected, the application is processed depending on the processing mode.

Moreover, a second information processing method according to the present invention is an information processing method in an information processing system for making communication between an input processing apparatus and an information processing apparatus and has the step of distinguishing the type of an input event on the basis of the coordinates of the input detected by an input detection section for detecting the proximity and contact of an object as input in the input processing apparatus; the step of acquiring the information of the processing mode for the application to be processed by the information processing apparatus in the input processing apparatus; the step of transmitting data including the information of the type of the distinguished event and the information of the acquired processing mode to the information processing apparatus in the input processing apparatus; the application processing step of processing an application for realizing predetermined functions in the input processing apparatus; the step of receiving the data from the input processing apparatus in the input processing apparatus; and the step of displaying the screen of the processed application via a display apparatus in the input processing apparatus, wherein, in the application processing step, in the case that the information of the type of the event is proximity detection information indicating that the proximity to the input detection section was detected, the information indicating the processing of the application in the processing mode is added to the screen of the application, and in the case that the information of the type of the event is contact detection information indicating that the contact to the input detection section was detected, the application is processed depending on the processing mode.

Besides, the input processing program according to the present invention is a program for causing a computer to execute the respective steps of the above-mentioned input processing method.

Additionally, a first information processing program according to the present invention is a program for causing a computer to execute the respective steps of the above-mentioned first information processing method.

Furthermore, a second information processing program according to the present invention is a program for causing a computer to execute the respective steps of the above-mentioned second information processing method.

With the present invention, effective and impressive presentation can be achieved.

### BRIEF DESCRIPTION OF THE DRAWINGS

FIG. 1 is a schematic view showing a configuration example of a presentation support system according to an embodiment.

FIG. 2 is a schematic view showing an example of the screen of a portable terminal according to the embodiment.

FIG. 3 is a block diagram showing configuration examples of the portable terminal and a PC.

FIGS. 4A to 4C are schematic views illustrating a pointer function in a presentation support system according to the embodiment.

FIGS. 5A to 5C are schematic views illustrating a pen function in the presentation support system according to the embodiment.

FIGS. 6A to 6C are schematic views illustrating a page function in the presentation support system according to the embodiment.

FIG. 7 is a flow chart showing an operation example of the portable terminal according to the embodiment.

FIG. 8 is a schematic view showing an example of the format of a message transmitted from the portable terminal to the PC according to the embodiment.

FIG. 9 is a flow chart showing an operation example of the PC according to the embodiment.

FIG. 10A to 10C are schematic views showing a modification example of the display form of a hover sign depending on the distance between a finger or the like and the touch panel in the case that the pen function according to the embodiment is used.

### DETAILED DESCRIPTION OF THE EXEMPLARY EMBODIMENTS

An embodiment according to the present invention will be described below referring to the drawings.

(Circumstance where an Embodiment According to the Present Invention was Obtained)

With the technologies described in JP-A-2002-351609 and JP-A-2013-073595, in the case that a small application screen is operated using an indicator for presentation or a touch panel type portable terminal, incorrect operation is liable to occur unless the user confirms the indicator or the terminal at hand and operates it. On the other hand, in the case that the user alternately confirms the indicator or the terminal at hand and, for example, the screen projected by a projector to avoid incorrect operation, natural presentation is disturbed. In this case, the quality of the presentation may become degraded.

An input processing apparatus, an information processing apparatus, an information processing system, an input processing method, an information processing method, an input processing program and an information processing program capable of achieving effective and impressive presentation will be described below.

### First Embodiment

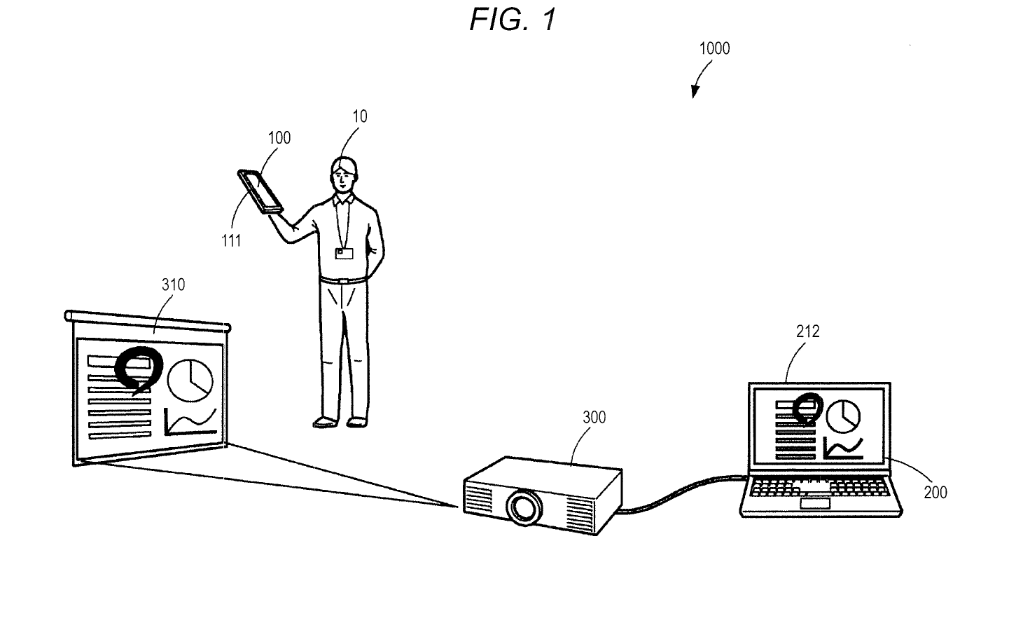

FIG. 1 is a schematic view showing a configuration example of a presentation support system 1000 according to an embodiment of the present invention. The presentation support system 1000 is equipped with a portable terminal 100, a PC 200 and a projector 300. The portable terminal 100 is connected to the PC 200 via a wireless communication line or a wired communication line.

The portable terminal 100 is an example of an input processing apparatus. The PC 200 is an example of an information processing apparatus. The presentation support system 1000 is an example of an information processing system.

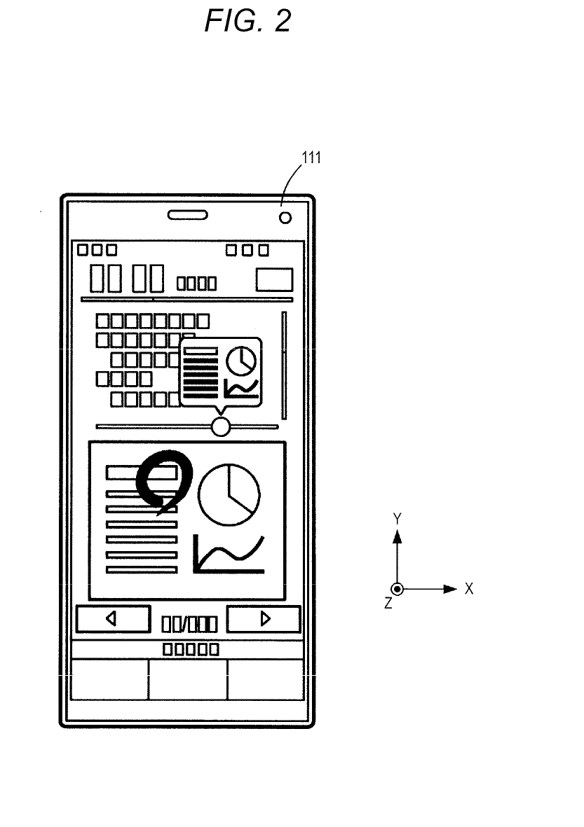

The portable terminal 100 is carried by a user 10 who performs presentation, for example. FIG. 2 is a schematic view showing an example of the screen 111 of the portable terminal 100, and in presentation, the screen 111 displayed on a display section included in the UI section 110 of the portable terminal 100 is almost synchronized with the screen 310 projected by the projector 300.

When the user 10 operates the portable terminal 100 using a touch panel included in the UI section 110 of the portable terminal 100, the portable terminal 100 detects a user operation and transmits, for example, data including the type of the event caused by the user operation (for example, a touch event or a hover event) to the PC 200. The information of the touch event is an example of contact detection information, and the information of the hover event is an example of proximity detection information.

The PC 200 receives the data including the information of the type of the event and processes an application depending on the type of the event. The result of processing the application using the PC 200 is reflected on the screen 111 of the portable terminal 100 and the screen 310 projected by the projector 300.

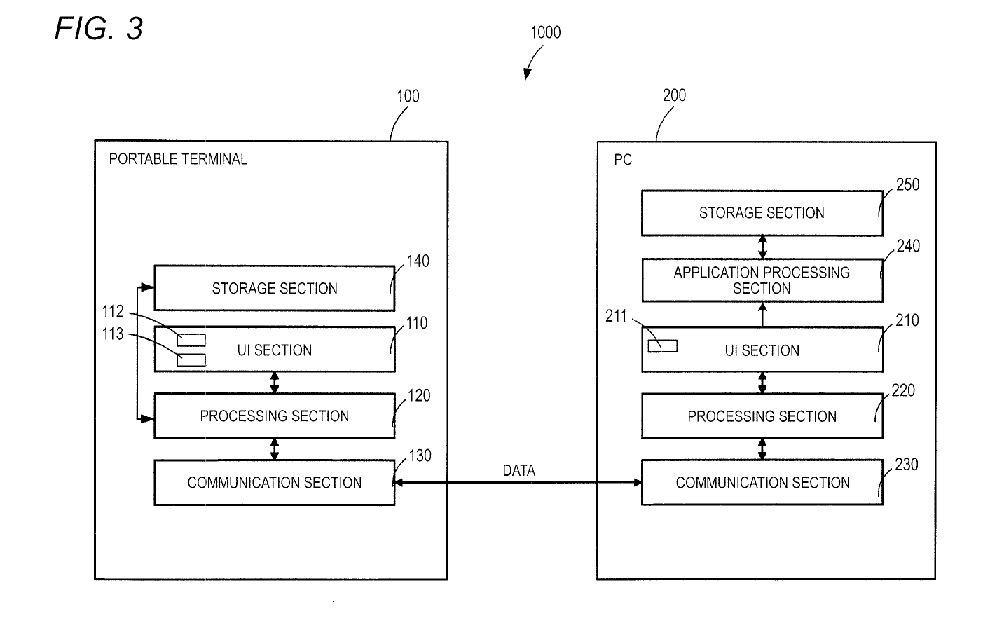

FIG. 3 is a block diagram showing configuration examples of the portable terminal 100 and the PC 200.

The portable terminal 100 is equipped with the UI (user interface) section 110, a processing section 120, a communication section 130 and a storage section 140.

It is assumed that examples of the portable terminal 100 include a smart phone, a portable telephone terminal and a portable information terminal. The main control system of the portable terminal 100 may be composed of dedicated hardware or may be mainly composed of a microcomputer. In the case the microcomputer is used, a required function is realized by reading a prepared control program and by executing the program using the microcomputer.

The UI section 110 mainly includes a configuration section relating to user interface, and includes, for example, a touch panel 112, a display section 113, a microphone and a speaker. For example, in the case that the touch panel 112 is a two-dimensional type, the UI section 110 is designed so as to be small in size to the extent that the user 10 needs confirmation at hand.

The display section 113 is composed of a display device having a display screen capable of displaying various kinds of visible information (for example, characters, figures and images), such as a liquid crystal panel. On the screen 111 of the display section 113, for example, the screen of an application processed by the PC 200 is displayed almost synchronously with the screen 310 projected by the projector 300. In the display on the display section 113, for example, the size and aspect ratio of the screen of the display section 113 is considered.

The touch panel 112 has, for example, a transparent operation surface capable of being touched by the user 10, and the operation surface is disposed in a state of being overlapped onto the screen 111 of the display section 113. For example, not only in a state (touch state) in which a finger of the user 10 or other object (hereafter referred to as the finger or the like) has touched the operation surface and but also in a proximity state (hover state), the touch panel 112 can detect the position of the finger or the like. An example of the other object includes a pen (stylus pen). The touch panel 112 is an example of an input detection section.

In addition, upon detecting of the state of the touch panel 112, the UI section 110 outputs information that can be used for the distinguishing of the operation state of the user 10. In other words, the UI section 110 outputs information indicating the position coordinates of the finger or the like that came close to or touched the operation surface of the touch panel 112.

The position coordinates include the coordinates of the positions in the X-axis direction and the Y-axis direction being parallel with the operation surface of the touch panel 112 and the coordinate of the position in the Z-axis direction being perpendicular to the X-axis and the Y-axis. The position in the Z-axis direction corresponds to the distance from the operation surface to the position of the finger or the like or corresponds to the height of the finger or the like from the operation surface.

For example, it is assumed that the value of the position in the Z-axis direction is 100% in the state in which the finger or the like touches the touch panel, that the value is 0% in the state in which the finger or the like is far away from the touch panel, and that the value is an intermediate value (for example, 50%) in the state in which the finger or the like is close to the touch panel. The value of the position in the Z-axis direction being output from the UI section 110 changes, for example, linearly depending on the change in the position of the finger or the like (depending on the distance from the touch panel).

The UI section 110 outputs the coordinate values on the respective axes (X, Y, Z) indicating the position of the finger or the like to the processing section 120 at a constant time interval, for example. The coordinate values of the position of the finger or the like are indicated by the position in the X-axis direction, the position in the Y-axis direction and the position in the Z-axis direction.

The processing section 120 controls the whole of the portable terminal 100 and performs, for example, various kinds of control, distinguishing, setting and processing. For example, the processing section 120 distinguishes the type of the event input in response to the pointing by the user 10 on the basis of the information of the coordinate values from the UI section 110. Examples of the type of the event include a hover event caused by the hover operation of the user 10 and a touch event caused by the touch operation of the user 10.

The processing section 120 compares, for example, the magnitude of the Z-coordinate at which the finger or the like was detected with a threshold value Th. For example, in the case that the magnitude of the Z-coordinate is larger than a first threshold value Th11, the processing section 120 does not detect the proximity or the contact of the finger or the like (the type of the event: none). Furthermore, for example, in the case that the magnitude of the Z-coordinate is equal to or smaller than the first threshold value Th11 and larger than a second threshold value Th12 (for example, Th2=0), the processing section 120 detects the proximity (the type of the event: Hover). Moreover, for example, in the case that the magnitude of the Z-coordinate is equal to or smaller than the second threshold value Th12, the processing section 120 detects the contact (the type of the event: Touch). The first threshold value Th11 is larger than the second threshold value Th12.

In other words, for example, in the case that the level of the signal detected by the touch panel 112 is smaller than a first threshold value Th21, the processing section 120 does not detect the proximity or contact (the type of the event: None). Furthermore, for example, in the case that the level of the detected signal is equal to or larger than the first threshold value Th21 and smaller than a second threshold value Th22, the processing section 120 detects the proximity (the type of the event: Hover). Moreover, for example, in the case that the level of the detected signal is equal to or larger than the second threshold value Th22, the processing section 120 detects the contact (the type of the event: Touch). The first threshold value Th21 is smaller than the second threshold value Th22.

Besides, in the processing section 120, the number of the threshold values Th may be increased so that the hover event is identified in multiple stages. With this arrangement, display control can be performed more minutely.

In addition, the processing section 120 sets the processing mode for an application to be processed by the PC 200, for example, by giving input through the touch panel 112 or by performing other methods. The processing mode includes, for example, a pointer mode (Pointer) in which a predetermined position is indicated in presentation and a writing mode (Pen) in which predetermined information (for example, line drawings or handwritten characters) is written on the screen 111 of the application. Furthermore, the processing mode includes, for example, a page feeding mode (Next) for changing the page being displayed (the current page) in presentation to pages subsequent to the page being displayed. Moreover, the processing mode includes, for example, a page returning mode (Previous (Prey)) for changing the page being displayed (the current page) in presentation to pages previous to the page being displayed. The page feeding mode and the page returning mode may be set as a single page operation mode.

The setting information of the processing mode is stored, for example, in the storage section 140. The processing section 120 reads the setting information of the processing mode from the storage section 140 at a predetermined timing, thereby acquiring the information. In addition, in the case that the processing mode is set to the page operation mode, the processing section 120 may distinguish whether the mode is the page feeding mode or the page returning mode depending on the region on the touch panel 112 in which a touch event or a hover event was detected.

The communication section 130 communicates with the PC 200 according to a predetermined communication system. An example of the predetermined communication system includes wireless LAN (local area network), infrared communication or Bluetooth (registered trademark).

The communication section 130 transmits, for example, data including the information of the type of the event and the information of the processing mode. Furthermore, the communication section 130 receives, for example, the information of the screen of the application from the PC 200. The information of the screen of the application is transmitted to the display section 113 of the UI section 110. Hence, the screen 111 of the portable terminal 100 can be almost synchronized with the screen 310 projected by the projector, and the user 10 can also confirm the screen of the application on the screen at hand.

The storage section 140 stores various kinds of information. The storage section 140 stores, for example, the setting information of the processing mode.

The PC 200 is equipped with a UI section 210, a processing section 220, a communication section 230, an application processing section 240 and a storage section 250.

The main control system of the PC 200 may be composed of dedicated hardware or may be mainly composed of a microcomputer. In the case the microcomputer is used, a required function is realized by reading a prepared control program and by executing the program using the microcomputer. In addition, the PC 200 may be an apparatus other than a PC and may be a smart phone or portable information terminal, for example.

The UI section 210 mainly includes a configuration section relating to user interface, and includes, for example, a touch panel, a display section 211, a microphone and a speaker.

The display section 211 is composed of a display device having a display screen capable of displaying various kinds of visible information (for example, characters, figures and images), such as a liquid crystal panel. On the screen 212 of the display section 211, for example, the screen of an application processed by the application processing section 240 is displayed almost synchronously with the screen 310 projected by the projector 300.

The processing section 220 controls the whole of the PC 200 and performs, for example, various kinds of control, distinguishing, setting and processing.

The communication section 230 communicates with the portable terminal 100 according to a predetermined communication system. An example of the predetermined communication system includes wireless LAN, infrared communication or Bluetooth (registered trademark).

The communication section 230 receives, for example, data including the information of the type of the event input through the portable terminal 100 and the information of the processing mode of the application. The communication section 230 transmits, for example, the information of the screen of the application to the portable terminal 100. With this transmission, the screen 111 of the portable terminal 100 can be almost synchronized with the screen 310 projected by the projector, and the user 10 can also confirm the screen of the application on the screen at hand.

The application processing section 240 processes various kinds of applications for realizing predetermined functions. Examples of specific applications are assumed to include an application for performing presentation, a map application, a player for reproducing contents (for example, still image or motion image contents), and a browser. An application is sometimes referred to as “app” or “appli”.

The application processing section 240 projects and displays, for example, the screen of an application via the communication section 230 and the projector 300. The application processing section 240 is an example of a display control section.

Furthermore, the application processing section 240 generates the screen of an application, for example, on the basis of at least the information of the type of the event or the information of the processes mode included in the data received via the communication section 230 and by adding the information stored in the storage section 250 to the information. In addition, the application processing section 240 processes, for example, the information (for example, marks) stored in the storage section 250 depending on the magnitude of the Z-coordinate.

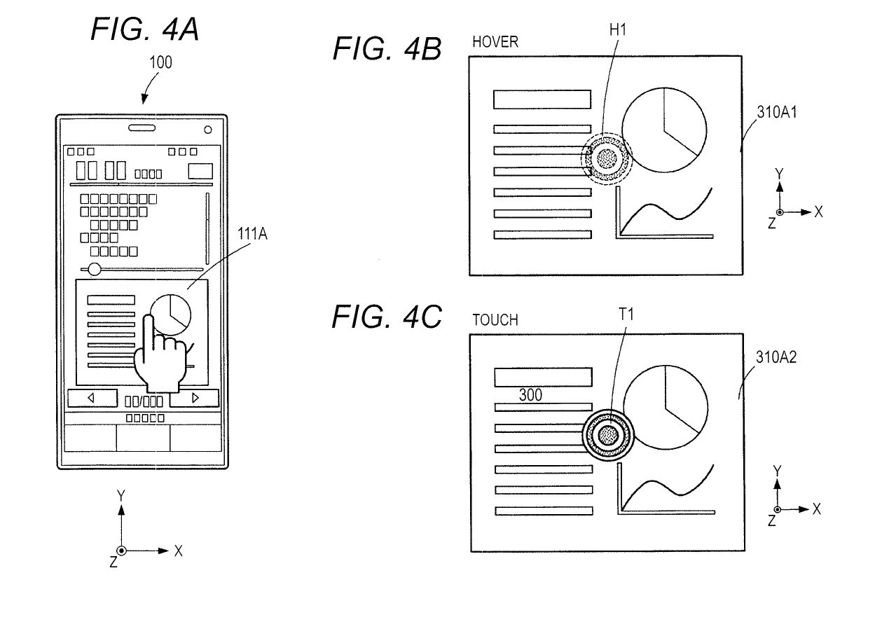

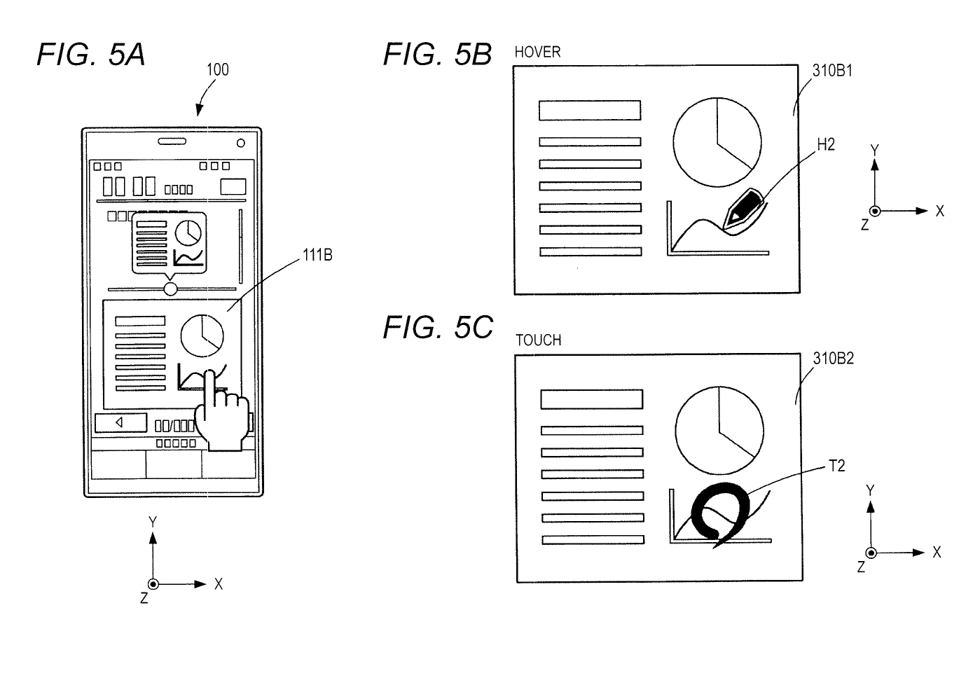

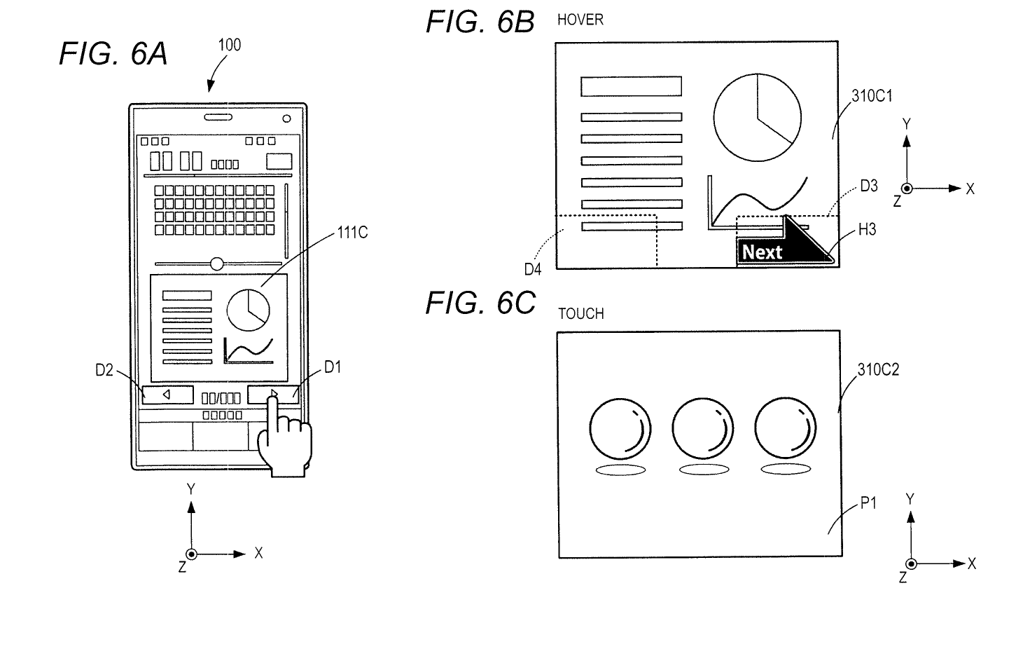

The storage section 250 stores various kinds of information. The storage section 250 stores, for example, the information of marks (for example, a hover mark H1 and a touch mark T1 in FIG. 4) displayed in the pointer mode and a mark (for example, a pen mark H2 in FIG. 5) displayed in the writing mode. In addition, the storage section 250 stores a mark (for example, a Next mark H3 in FIG. 6) displayed in the page feeding mode or the page returning mode.

Furthermore, in the case that display information being different depending on whether the event is a touch event or a hover event is displayed in each mode, the storage section 250 may store the display information corresponding to both events or may store processed information obtained by processing the display information of one of the events using the processing section 120.

The projector 300 acquires the information of the screen of the application from the PC 200 via a wired line or a wireless line and projects the screen 310 of the application onto a wall surface, for example. Furthermore, instead of the projector 300, for example, a display apparatus having a large display may also be used.

Next, the presentation support functions provided by the presentation support system 1000 will be described. The presentation support system 1000 detects the touch event and the hover event using the portable terminal 100, thereby providing various kinds of presentation support functions.

The presentation support functions include, for example, a page operation function, a pointer function and a pen function.

FIGS. 4A to 4C are schematic views illustrating the pointer function in the presentation support system 1000. FIG. 4A shows, for example, a screen 111A that is displayed on the portable terminal 100 in the case that the pointer function is used in presentation. The touch operation or the hover operation is performed using the finger or the like for the touch panel 112 disposed on the screen 111A. Since the pointer function is herein used, information indicating that the pointer mode has been set as the processing mode is stored in the storage section 140.

FIG. 4B is a schematic view showing a display example of a screen 310A1 projected by the projector 300 in the case that a hover operation was performed in the portable terminal 100. When the hover operation is performed for the touch panel 112, the portable terminal 100 detects a hover event depending on the position (the position of the XY-coordinates or the position of the XYZ-coordinates) at which the hover operation was performed. The portable terminal 100 transmits data including information indicating that the type of the event is “Hover” and that the processing mode is “Pointer” to the PC 200.

The position at which the hover event is detected in the pointer mode is a position in a region other than predetermined regions (for example, regions D1 and D2 in FIG. 6) on the touch panel 112 in which page feeding and page returning are performed.

Upon receiving the data from the portable terminal 100, the PC 200 refers to the data stored in the storage section 250 and adds the hover mark H1 at the position in which the hover event was detected on the screen 111A. The PC 200 transmits the information of the screen of the application to which the hover mark H1 was added to the projector 300 and the portable terminal 100. The projector 300 projects the screen 310A1 of the application transmitted from the PC 200.

The hover mark H1 is an example of the information indicating that a hover event was detected in the pointer mode and preliminarily indicates the position to be touched in the case that the finger or the like of the user 10 further approached the touch panel 112 from the hover state thereof. Furthermore, the hover mark H1 is an example of a hover sign. The hover sign is information indicating a process for an application in a predetermined processing mode.

The PC 200 may change the size of the hover mark H1 stepwise depending on the magnitude of the Z-coordinate detected in the hover event. For example, the display form of the hover mark H1 may be changed such that the circle of the mark is indicated larger as the magnitude of the Z-coordinate is larger and such that the circle is indicated smaller as the magnitude of the Z-coordinate is smaller in the range in which the hover event is detected. In the case that the magnitude of the Z-coordinate became further smaller and a touch event was detected, the display form of the hover mark H1 may be changed so as to be converged to a predetermined position (for example, the position of the XY-coordinates at which the hover event was detected).

For example, the size of the hover mark H1 to be added may be determined by multiplying the size (the original size) of the hover mark H1 or the touch mark T1 read from the storage section 250 by a constant corresponding to the magnitude of the Z-coordinate.

Furthermore, instead of the size of the hover mark H1, the magnitude of the Z-coordinate may be indicated so as to be different in the gradation of the displayed color of the hover mark H1. Moreover, the display form may be changed to other display forms (for example, forms being different in line thickness and transparency).

For example, the processing section 220 acquires the hover mark H1 or the touch mark T1 stored in the storage section 250 and processes the hover mark H1 or the touch mark T1 according to a method for changing a preset display form.

FIG. 4C is a schematic view showing a display example of a screen 310A2 projected by the projector 300 in the case that a touch operation was performed in the portable terminal 100. When the touch operation is performed for the touch panel 112, the portable terminal 100 detects a touch event depending on the position (the position of the XY-coordinates) at which the touch operation was performed. The portable terminal 100 transmits data including information indicating that the type of the event is “Touch” and that the processing mode is “Pointer” to the PC 200.

The position at which the touch event is detected in the pointer mode is a position in a region other than predetermined regions (for example, the regions D1 and D2 in FIG. 6) on the touch panel 112 in which page feeding and page returning are performed.

Upon receiving the data from the portable terminal 100, the PC 200 refers to the data stored in the storage section 250 and adds the touch mark T1 at the position in which the touch event was detected on the screen 111A. The PC 200 transmits the information of the screen of the application to which the touch mark T1 was added to the projector 300 and the portable terminal 100. The projector 300 projects the screen 310A2 of the application transmitted from the PC 200.

The touch mark T1 is an example of the information indicating that a touch event was detected in the pointer mode and is displayed as in the case that pointing was done using a laser pointer, for example. Furthermore, the touch mark T1 is an example of a touch sign. The touch sign is an example of the processing result of the application depending on a predetermined processing mode.

With the pointer function, it is possible to confirm the hover mark H1 that is displayed auxiliarily on the screen 310 projected by the projector 300 in correspondence to the detection of a hover event in response to the operation of the user 10. Hence, the user 10 can point the desired position on the screen of the application while suppressing incorrect operation without confirming the screen 111A of the portable terminal 100 at hand.

FIGS. 5A to 5C are schematic views illustrating the pen function in the presentation support system 1000. FIG. 5A shows, for example, a screen 111B that is displayed on the portable terminal 100 in the case that the pen function is used in presentation. The touch operation or the hover operation is performed using the finger or the like for the touch panel 112 disposed on the screen 111B. Since the pen function is herein used, information indicating that the writing mode has been set as the processing mode is stored in the storage section 140.

FIG. 5B is a schematic view showing a display example of a screen 310B1 projected by the projector 300 in the case that a hover operation was performed in the portable terminal 100. When the hover operation is performed for the touch panel 112, the portable terminal 100 detects a hover event depending on the position (the position of the XY-coordinates or the position of the XYZ-coordinates) at which the hover operation was performed. The portable terminal 100 transmits data including information indicating that the type of the event is “Hover” and that the processing mode is “Pen” to the PC 200.

The position at which the hover event is detected in the writing mode is a position in a region other than predetermined regions (for example, the regions D1 and D2 in FIG. 6) on the touch panel 112 in which page feeding and page returning are performed.

Upon receiving the data from the portable terminal 100, the PC 200 refers to the data stored in the storage section 250 and adds the pen mark H2 at the position in which the hover event was detected on the screen 111B. The PC 200 transmits the information of the screen of the application to which the pen mark H2 was added to the projector 300 and the portable terminal 100. The projector 300 projects the screen 310B1 of the application transmitted from the PC 200.

The pen mark H2 is an example of the information indicating that a hover event was detected in the writing mode and preliminarily indicates the position to be touched in the case that the finger or the like of the user 10 further approached the touch panel 112 from the hover state thereof. Furthermore, the pen mark H2 is an example of the hover sign.

The PC 200 may change the size of the pen mark H2 stepwise depending on the magnitude of the Z-coordinate detected in the hover event. For example, the display form of the pen mark H2 may be changed such that the pen mark H2 is indicated larger as the magnitude of the Z-coordinate is larger and such that the pen mark H2 is indicated smaller as the magnitude of the Z-coordinate is smaller in the range in which the hover event is detected.

For example, the size of the pen mark H2 to be added may be determined by multiplying the size (the original size) of the pen mark H2 read from the storage section 250 by a constant corresponding to the magnitude of the Z-coordinate.

Furthermore, instead of the size of the pen mark H2, the magnitude of the Z-coordinate may be indicated so as to be different in the gradation of the displayed color of the pen mark H2. Moreover, the display form may be changed to other display forms (for example, forms being different in line thickness and transparency).

For example, the processing section 220 acquires the pen mark H2 stored in the storage section 250 and processes the pen mark H2 according to a method for changing a preset display form.

Furthermore, a mark other than the pen mark may also be used to indicate the hover state in which the pen function is used. For example, the processing section 220 may change the mark to be displayed depending on input means for performing input operation to the portable terminal 100. For example, the processing section 220 may display a finger mark in the case that a finger serving as input means approached the touch panel, and may display the pen mark in the case that a pen serving as input means approached the touch panel.

FIG. 6C is a schematic view showing a display example of a screen 310B2 projected by the projector 300 in the case that a touch operation was performed in the portable terminal 100. When the touch operation is performed for the touch panel 112, the portable terminal 100 detects a touch event depending on the position (the position of the XY-coordinates) at which the touch operation was detected. The portable terminal 100 transmits data including information indicating that the type of the event is “Touch” and that the processing mode is “Pen” to the PC 200.

The position at which the touch event is detected in the writing mode is a position in a region other than predetermined regions (for example, the regions D1 and D2 in FIG. 6) on the touch panel 112 in which page feeding and page returning are performed.

Upon receiving the data from the portable terminal 100, the PC 200 adds a line part T2 written using the pen function along the position at which the touch event was detected on the screen 111B. The PC 200 transmits the information of the screen of the application to which the line part T2 was added to the projector 300 and the portable terminal 100. Hence, the line part T2 can be written by using the position at which the touch event was detected as the starting point. The projector 300 projects the screen 310B2 of the application transmitted from the PC 200.

The line part T2 is an example of the information indicating that a touch event was detected in the writing mode and indicates the locus of the information written using the original pen function. Furthermore, the line part T2 is an example of a touch sign.

With the pen function, it is possible to confirm the pen mark H2 that is displayed auxiliarily on the screen 310 projected by the projector 300 in correspondence to the detection of a hover event in response to the operation of the user 10. Hence, the user 10 can write the line part T2 at the desired position on the screen of the application while suppressing incorrect operation without confirming the screen 111B of the portable terminal 100 at hand.

FIGS. 6A to 6C are schematic views illustrating the page operation function in the presentation support system 1000. FIG. 6A shows, for example, a screen 111C that is displayed on the portable terminal 100 in the case that the page operation function is used in presentation. The touch operation or the hover operation is performed using the finger or the like for the touch panel 112 disposed on the screen 111C. Since the page change function is herein used, information indicating that the page feeding mode, the page returning mode or the page operation mode has been set as the processing mode is stored in the storage section 140. It is assumed herein that the page is changed to the next page (page feeding).

FIG. 6B is a schematic view showing a display example of a screen 310C1 projected by the projector 300 in the case that a hover operation was performed in the portable terminal 100. When the hover operation is performed in the predetermined region of the touch panel 112, the portable terminal 100 detects a hover event depending on the position (the position of the XY-coordinates or the position of the XYZ-coordinates) at which the hover operation was performed. The portable terminal 100 transmits data including information indicating that the type of the event is “Hover” and that the processing mode is “Next” or “Prey” to the PC 200. The predetermined region includes the region D1 in which the touch event for page feeding is detected or the region D2 in which the touch event for page returning is detected.

Upon receiving the data from the portable terminal 100, the PC 200 refers to the data stored in the storage section 250 and adds page change pre-notice information (for example, a Next mark H3) for preliminarily giving a notice of page change. The PC 200 transmits the information of the screen of the application to which the page change pre-notice information was added to the projector 300 and the portable terminal 100. The projector 300 projects the screen 310C1 of the application transmitted from the PC 200.

The Next mark H3 is an example of the information for preliminarily giving the notice of the page change operation of the portable terminal 100 in the case that a touch operation was performed in the predetermined region. Furthermore, the Next mark H3 is an example of the hover sign.

In FIG. 6B, the PC 200 detects a hover event in the region D1 and displays the Next mark H3 as the page change pre-notice information in the region D3 corresponding to the region D1. Furthermore, the PC 200 displays a Prey mark (not shown) as the page change pre-notice information in the region D4 corresponding to the region D2.

FIG. 6C is a schematic view showing a display example of a screen 310C2 projected by the projector 300 in the case that a touch operation was performed in the portable terminal 100. When the touch operation is performed for the predetermined region of the touch panel 112, the portable terminal 100 detects a touch event depending on the position (the position of the XY-coordinates) at which the touch operation was performed. The portable terminal 100 transmits data including information indicating that the type of the event is “Touch” and that the processing mode is “Next” or “Prey” to the PC 200. The predetermined region includes, for example, the region D1 or the region D2.

Upon receiving the data from the portable terminal 100, the PC 200 changes the page depending on the processing mode. For example, in the case that the processing mode is “Next”, the PC 200 changes the current page to a subsequent page P1 (for example, the next page). Furthermore, in the case that the processing mode is “Prey”, the PC 200 changes the current page to a previous page (for example, the immediately previous page). The PC 200 transmits the information of the screen of the application on which the page change was performed to the projector 300 and the portable terminal 100. The projector 300 projects the screen 310C2 of the application transmitted from the PC 200.

With the page operation function, it is possible to confirm the page change pre-notice information (for example, the Next mark H3) displayed auxiliarily on the screen 310 projected by the projector 300 in correspondence to the detection of a hover event in response to the operation of the user 10. Hence, the user 10 can change the page displayed on the screen of the application to other pages while suppressing incorrect operation without confirming the screen 111C of the portable terminal 100 at hand.

In FIGS. 4A to 4C to FIGS. 6A to 6C, the page operation function may be set so as to be combined with the pointer function or with the pen function, or may be set independently.

Next, an operation example of the presentation support system 1000 will be described.

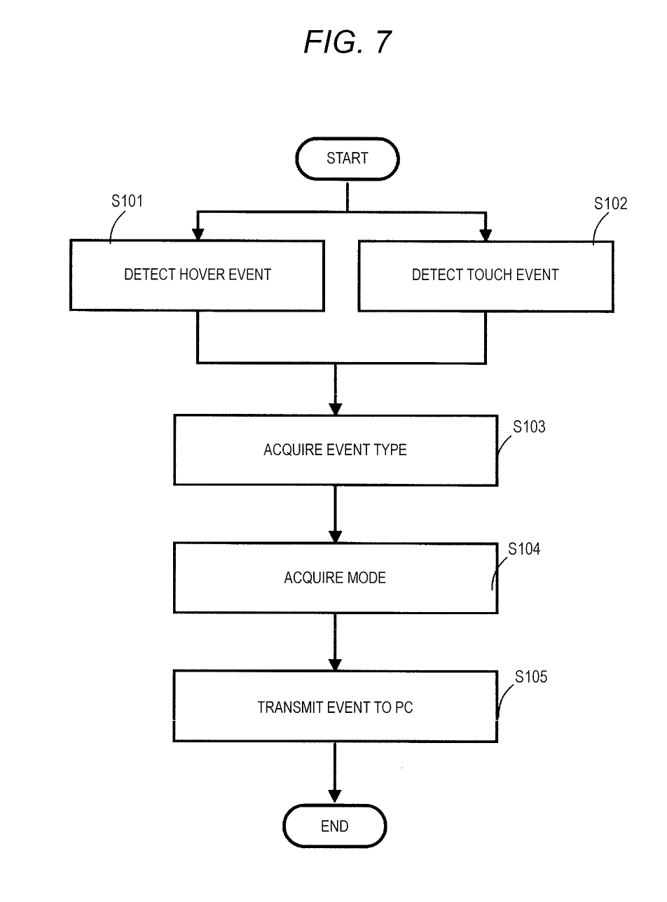

FIG. 7 is a flow chart showing an operation example of the portable terminal 100.

First, the UI section 110 receives a hover operation or a touch operation for the touch panel 112 of the portable terminal 100. The processing section 120 detects a hover event or a touch event on the basis of the coordinates input by the hover operation or the touch operation (at S101, at S102).

Then, the processing section 120 acquires the information of the type of the detected event (at S103). The information of the type of the event includes, for example, “Touch” indicating that a touch event was detected, “Hover” indicating that a hover event was detected, or “None” indicating that neither a touch event nor a hover event was detected.

Next, the processing section 120 acquires the information of the processing mode for an application set in the portable terminal 100 (at S104). The information of the processing mode includes information indicating that the mode is, for example, “Pointer”, “Pen”, “Next” or “Prey” and the information is stored in the storage section 140 at a predetermined timing.

For example, in the case that the pointer function has been set, the processing section 120 acquires the information indicating that the mode is “Pointer”. Furthermore, in the case that the pen function has been set, the processing section 120 acquires the information indicating that the mode is “Pen”. Moreover, in the case that the page operation function has been set, the processing section 120 acquires at least either the information indicating that the mode is “Next” or the information indicating that the mode is “Prey”. Still further, in the case that the page operation function has been set, the processing section 120 may acquire either the information indicating that the mode is “Next” or the information indicating that the mode is “Prey” depending on the region on the touch panel 112 in which the touch event or the hover event was detected.

Then, the communication section 130 transmits a message M1 including the information of the type of the event and the information of the set processing mode to the PC 200 (at S105). The message M1 is an example of data transmitted from the portable terminal 100 to the PC 200.

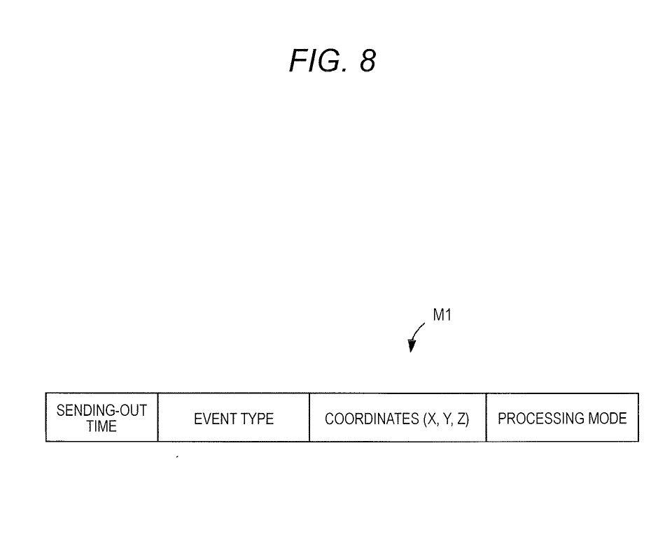

FIG. 8 is a schematic view showing an example of the format of the message M1. The message M1 includes the information of sending-out time serving as transmission time in the transmission using the portable terminal 100, event type, coordinates (for example, X, Y, Z) input to and detected by the touch panel 112, and processing mode. The message M1 may include additional information other than the above-mentioned information. It is assumed that messages for use in applications processed by the PC 200 may have formats other than that of the message M1. The information of coordinates may not be included in the message M1.

According to an operation example of the portable terminal 100, even in the case that the user 10 operates the screen of an application using the portable terminal 100, the user 10 can confirm the display for assisting the user operation on the screen of the application projected by the projector 300, whereby incorrect operation can be suppressed. In addition, the user 10 is not required to alternately confirm the screen of the portable terminal 100 at hand and, for example, the screen projected by the projector 300, whereby natural presentation can be performed. Hence, effective and impressive presentation can be achieved.

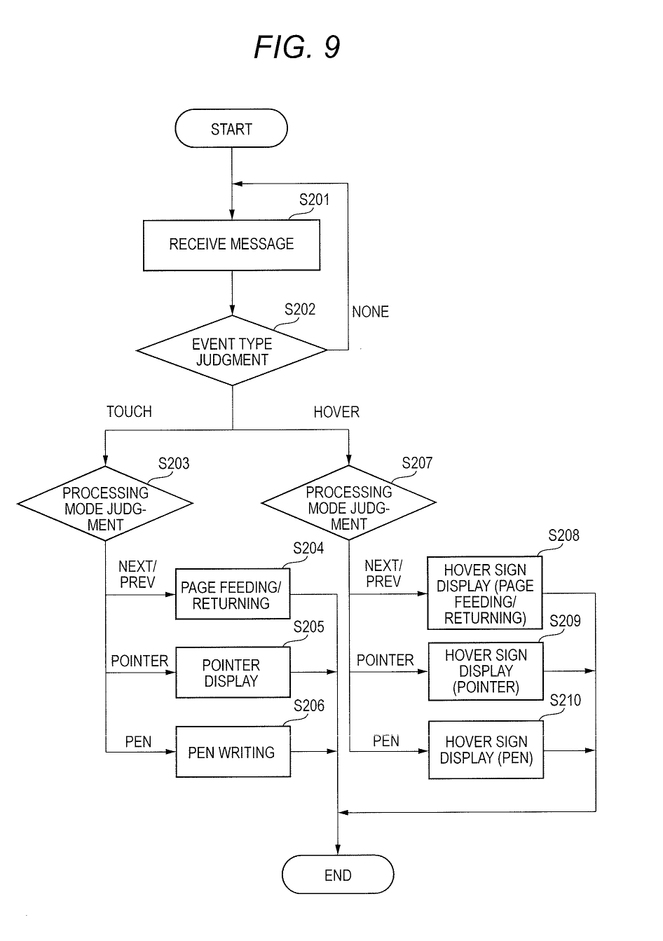

FIG. 9 is a flow chart showing an operation example of the PC 200.

First, the communication section 230 receives the message M1 from the portable terminal 100 (at S201).

Next, the processing section 220 refers to the event type information included in the received message and judges the type of the event generated in the portable terminal 100 (at S202).

In the case that the event type is “Touch”, the processing section 220 refers to the processing mode information included in the message M1 and judges the processing mode of the portable terminal 100 (at S203).

In the case that the processing mode is “Next”, the application processing section 240 changes the current page to, for example, the immediately subsequent page (at S204). Furthermore, in the case that the processing mode is “Prey”, the application processing section 240 changes the current page to, for example, the immediately previous page (at S204).

Although the operation for changing the current page to the immediately subsequent page or the immediately previous page was exemplified at S204, the application processing section 240 may change the current page by the preliminarily specified number of pages backward or forward.

In the case that the processing mode is “Pointer”, the application processing section 240 displays a pointer on the current page (at S205). For the display of the pointer, the application processing section 240 displays, for example, the touch mark T1 shown in FIG. 4 in the region indicated by the information of the coordinates (X, Y) included in the message M1.

In the case that the processing mode is “Pen”, the application processing section 240 performs writing using the pen function on the current page (at S206). For the writing using the pen function, the application processing section 240 displays, for example, the line part T2 shown in FIG. 5 in the region indicated by the information of the coordinates (X, Y) included in the message M1.

In the case that the event type distinguished at S202 is “Hover”, the processing section 220 refers to the processing mode information included in the message M1 and judges the processing mode of the portable terminal 100 (at S207).

In the case that the processing mode is “Next”, the application processing section 240 displays information indicating that the current page is changed to, for example, the immediately subsequent page as a hover sign (at S208). For the display of the hover sign, the application processing section 240 displays, for example, the Next mark H3 shown in FIG. 6 in a predetermined region (for example, the region D3).

In the case that the processing mode is “Prey”, the application processing section 240 displays information indicating that the current page is changed to, for example, the immediately previous page as a hover sign (at S208). For the display of the hover sign, the application processing section 240 displays, for example, the Prey mark in a predetermined region (for example, the region D4).

In the case that the processing mode is “Pointer”, the application processing section 240 displays information indicating the position of the pointer on the current page as a hover sign (at S209). For the display of the hover sign, the application processing section 240 displays the hover mark H1 shown in FIG. 4 in the region indicated by the information of the coordinates included in the message M1.

In the case that the processing mode is “Pen”, the application processing section 240 displays information indicating the position of the writing using the pen function on the current page (at S206). For the display of the hover sign, the application processing section 240 displays the pen mark H2 shown in FIG. 5 in the region indicated by the information of the coordinates included in the message M1.

According to an operation example of the PC 200, even in the case that the user 10 operates the screen of an application using the portable terminal 100, the user 10 can display information (hover sign) for assisting the user operation, for example, on the screen of the application projected by the projector 300. Hence, the user 10 can preliminarily confirm the content of the operation, for example, on the screen of the application projected by the projector 300, and can prevent incorrect operation without confirming the screen of the portable terminal 100 at hand. In addition, the user 10 is not required to alternately confirm the screen of the portable terminal 100 at hand and, for example, the screen projected by the projector 300, whereby natural presentation can be performed. Hence, effective and impressive presentation can be achieved.

Next, a modification example of the display form of the hover sign will be described.

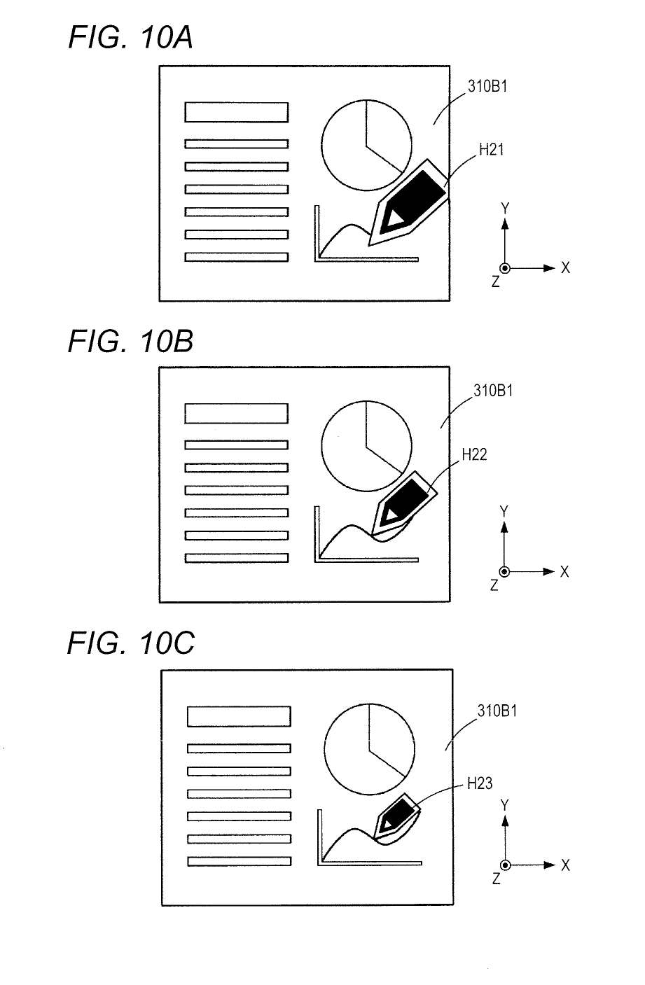

FIGS. 10A to 10C are schematic views showing a modification example of the display form of the pen mark H2. The display form of the pen mark H2 is changed, for example, depending on the magnitude of the Z-coordinate. Also, in the case that the sizes of the other marks (for example, the hover mark H1 and the Next mark H3) are changed, they are changed similarly. Pen marks H21 to H23 described below are examples of the pen mark H2.

In FIG. 10A, when the touch panel 112 detects the proximity of the finger or the like, the application processing section 240 displays the pen mark H2 by using the position of the finger or the like as a reference (for example, its center) on an application screen 310B1. In the case that the finger or the like is relatively away from the touch panel 112, the application processing section 240 displays the pen mark H21 so as to be large in size. The pen mark H21 may protrude from the screen as shown in FIG. 10A.

When the finger or the like is brought close to the touch panel 112 from the state shown in FIG. 10A, the application processing section 240 displays the pen mark H22 so as to be smaller than the pen mark H21 by using the position of the finger or the like as a reference.

When the finger or the like is further brought close to the touch panel 112, the application processing section 240 displays the pen mark H23 so as to be smaller than the pen mark H22 as shown in FIG. 10C. Hence, the position attempted to be touched with the finger or the like can be recognized accurately.

The pen mark H2 is a moving image that is deformed as if the pen mark H2 comes close at nearly the same speed from a plurality of directions corresponding to the peripheral edges of the pen mark H2, for example, when its size becomes smaller on the basis of the Z-coordinate. Hence, when the size becomes smaller, the shape of the pen mark H2 is prevented from being distorted.

Since the pen mark H2 gradually becomes smaller as the distance between the finger or the like and the touch panel 112 becomes shorter as described above, the user 10 can easily visually recognize the position attempted to be touched. In addition, the user 10 can recognize how much the finger or the like is away from the touch panel 112 depending on the size of the pen mark H2.

On the other hand, in the state in which the finger or the like has touched the touch panel 112, the pen mark H2 does not appear on the application screen. When the finger or the like moves slightly away from the touch panel 112, the application processing section 240 may display the pen mark H2 by using the position of the finger or the like having touched the touch panel as a reference.

The present invention is not limited to the above-mentioned embodiment, but is applicable to any configurations, provided that the functions described in the claims or the functions of the configuration of the embodiment can be attained.

For example, in the above-mentioned embodiment, the information of the screen of the application to which the hover sign was added may be transmitted to only the projector 300 and may not be transmitted to the portable terminal 100.

### (General Description of an Embodiment of the Present Invention)

An input processing apparatus according to an embodiment of the present invention is an input processing apparatus for communicating with an information processing apparatus and is equipped with an input detection section for detecting the proximity and contact of an object as input; an event type distinguishing section for distinguishing the type of an input event on the basis of the coordinates of the input detected by the input detection section; a mode information acquiring section for acquiring the information of the processing mode for an application to be processed by the information processing apparatus; and a transmission section for transmitting data including the information of the type of the event distinguished by the event type distinguishing section and the information of the processing mode acquired by the mode information acquiring section to the information processing apparatus.

In addition, in the input processing apparatus according to the embodiment of the present invention, the information of the type of the event includes proximity detection information indicating that the proximity was detected by the input detection section and contact detection information indicating that the contact was detected by the input detection section.

Furthermore, in the input processing apparatus according to the embodiment of the present invention, the information of the processing mode includes a pointer mode in which a pointer indicates a predetermined position on the screen of the application, a writing mode in which writing is made on the screen of the application, a page feeding mode in which the current page is changed to subsequent pages or a page returning mode in which the current page is returned to previous pages.

Moreover, the input processing apparatus according to the embodiment of the present invention is equipped with a receiving section for receiving the information of the screen of the application processed by the input processing apparatus and a display section for displaying the screen of the application received by the receiving section.

Besides, the information processing apparatus according to the embodiment of the present invention is an information processing apparatus for communicating with an input processing apparatus and is equipped with an application processing section for processing an application for realizing predetermined functions; a receiving section for receiving data including the information of the type of the event input to the input processing apparatus and the information of the processing mode of the application to be processed by the application processing section from the input processing apparatus; and a display control section for displaying the screen of the application processed by the application processing section via a display apparatus, wherein, in the case that the information of the type of the event is proximity detection information indicating that the proximity to the input detection section of the input processing apparatus was detected, the application processing section adds the information indicating the processing of the application in the processing mode to the screen of the application, and in the case that the information of the type of the event is contact detection information indicating that the contact to the input detection section of the input processing apparatus was detected, the application processing section processes the application depending on the processing mode.

What' more, in the information processing apparatus according to the embodiment of the present invention, the information of the processing mode includes a pointer mode in which a pointer indicates a predetermined position on the screen of the application, a writing mode in which writing is made on the screen of the application, a page feeding mode in which the current page is changed to subsequent pages or a page returning mode in which the current page is returned to previous pages.

Still further, the information processing apparatus according to the embodiment of the present invention is equipped with a transmission section for transmitting the information of the screen of the application processed by the application processing section to the portable terminal.

Additionally, an information processing system according to the embodiment of the present invention is an information processing system for making communication between an input processing apparatus and an information processing apparatus, wherein the input processing apparatus is equipped with an input detection section for detecting the proximity and contact of an object as input; an event type distinguishing section for distinguishing the type of an input event on the basis of the coordinates of the input detected by the input detection section; a mode information acquiring section for acquiring the information of the processing mode for an application to be processed by the information processing apparatus; a transmission section for transmitting data including the information of the type of the event distinguished by the event type distinguishing section and the information of the processing mode acquired by the mode information acquiring section to the information processing apparatus, and the information processing apparatus is equipped with an application processing section for processing an application for realizing predetermined functions; a receiving section for receiving the data from the input processing apparatus; and a display control section for displaying the screen of the application processed by the application processing section via a display apparatus, wherein, in the case that the information of the type of the event is proximity detection information indicating that the proximity to the input detection section was detected, the application processing section adds the information indicating the processing of the application in the processing mode to the screen of the application, and in the case that the information of the type of the event is contact detection information indicating that the contact to the input detection section was detected, the application processing section processes the application depending on the processing mode.

Further, an input processing method according to the embodiment of the present invention is an input processing method in an input processing apparatus for communicating with an information processing apparatus and has the step of distinguishing the type of an input event on the basis of the coordinates of the input detected by an input detection section for detecting the proximity and contact of an object as input; the step of acquiring the information of the processing mode for an application to be processed by the information processing apparatus; and the step of transmitting data including the information of the type of the distinguished event and the information of the acquired processing mode to the information processing apparatus.

Furthermore, a first information processing method according to the embodiment of the present invention is an information processing method in an information processing apparatus for communicating with an input processing apparatus and has the application processing step of processing an application for realizing predetermined functions; the step of receiving data including the information of the type of the event input to the input processing apparatus and the information of the processing mode of the application to be processed from the input processing apparatus; and the step of displaying the screen of the processed application via a display apparatus, wherein, in the application processing step, in the case that the information of the type of the event is proximity detection information indicating that the proximity to the input detection section of the input processing apparatus was detected, the information indicating the processing of the application in the processing mode is added to the screen of the application, and in the case that the information of the type of the event is contact detection information indicating that the contact to the input detection section of the input processing apparatus was detected, the application is processed depending on the processing mode.

Moreover, a second information processing method according to the embodiment of the present invention is an information processing method in an information processing system for making communication between an input processing apparatus and an information processing apparatus and has the step of distinguishing the type of an input event on the basis of the coordinates of the input detected by an input detection section for detecting the proximity and contact of an object as input in the input processing apparatus; the step of acquiring the information of the processing mode for the application to be processed by the information processing apparatus in the input processing apparatus; the step of transmitting data including the information of the type of the distinguished event and the information of the acquired processing mode to the information processing apparatus in the input processing apparatus; the application processing step of processing an application for realizing predetermined functions in the input processing apparatus; the step of receiving the data from the input processing apparatus in the input processing apparatus; and the step of displaying the screen of the processed application via a display apparatus in the input processing apparatus, wherein, in the application processing step, in the case that the information of the type of the event is proximity detection information indicating that the proximity to the input detection section was detected, the information indicating the processing of the application in the processing mode is added to the screen of the application, and in the case that the information of the type of the event is contact detection information indicating that the contact to the input detection section was detected, the application is processed depending on the processing mode.

Besides, an input processing program according to the embodiment of the present invention is a program for causing a computer to execute the respective steps of the input processing method.

Furthermore, a first information processing program according to the embodiment of the present invention is a program for causing a computer to execute the respective steps of the first information processing method.

Still further, a second information processing program according to the embodiment of the present invention is a program for causing a computer to execute the respective steps of the second information processing method.

The present application is based on Japanese Patent Application No. 2013-122796 filed on Jun. 11, 2013, the contents of which are incorporated herein by reference.

What is claimed is:

1. An input processing apparatus for communicating with an information processing apparatus, comprising:
an input detection section configured to detect a proximity and a contact of an object as input;
an event type distinguishing section configured to distinguish a type of an input event on the basis of coordinates of the input detected by the input detection section;
a mode information acquiring section configured to acquire information of a processing mode for an application to be processed by the information processing apparatus; and
a transmission section configured to transmit data including the information of the type of the event distinguished by the event type distinguishing section and the information of the processing mode acquired by the mode information acquiring section to the information processing apparatus.

2. The input processing apparatus according to claim 1, wherein the information of the type of the event includes proximity detection information indicating that the proximity of the object is detected by the input detection section and contact detection information indicating that the contact of the object is detected by the input detection section.

3. The input processing apparatus according to claim 2, wherein the information of the processing mode includes a pointer mode in which a pointer indicates a predetermined position on the screen of the application, a writing mode in which writing is made on the screen of the application, a page feeding mode in which the current page is changed to subsequent pages, or a page returning mode in which the current page is returned to previous pages.

4. The input processing apparatus according to claim 1, further comprising:
a receiving section configured to receive the information of the screen of the application processed by the input processing apparatus; and
a display section configured to display the screen of the application received by the receiving section.

5. An information processing apparatus for communicating with an input processing apparatus, comprising:
an application processing section configured to process an application for realizing predetermined functions;
a receiving section configured to receive data including the information of the type of the event input to the input processing apparatus and the information of the processing mode of the application to be processed by the application processing section from the input processing apparatus; and
a display control section configured to display the screen of the application processed by the application processing section via a display apparatus,
wherein in a case that the information of the type of the event is proximity detection information indicating that the proximity of the object to the input detection section of the input processing apparatus is detected, the application processing section adds the information indicating the processing of the application in the processing mode to the screen of the application, and in a case that the information of the type of the event is contact detection information indicating that the contact of the object to the input detection section of the input processing apparatus is detected, the application processing section processes the application depending on the processing mode.

6. The information processing apparatus according to claim 5, wherein the information of the processing mode includes a pointer mode in which a pointer indicates a predetermined position on the screen of the application, a writing mode in which writing is made on the screen of the application, a page feeding mode in which the current page is changed to subsequent pages, or a page returning mode in which the current page is returned to previous pages.

7. The information processing apparatus according to claim 5, further comprising:
a transmission section configured to transmit the information of the screen of the application processed by the application processing section to the input processing apparatus.

8. An information processing system for making communication between an input processing apparatus and an information processing apparatus, wherein the input processing apparatus comprises:
an input detection section configured to detect a proximity and a contact of an object as input;
an event type distinguishing section configured to distinguish the type of an input event on the basis of coordinates of the input detected by the input detection section;
a mode information acquiring section configured to acquire the information of the processing mode for an application to be processed by the information processing apparatus; and
a transmission section configured to transmit data including the information of the type of the event distinguished by the event type distinguishing section and the information of the processing mode acquired by the mode information acquiring section to the information processing apparatus;
wherein the information processing apparatus comprises:
an application processing section configured to process an application for realizing predetermined functions;
a receiving section configured to receive the data from the input processing apparatus; and
a display control section configured to display the screen of the application processed by the application processing section via a display apparatus; and
wherein in a case that the information of the type of the event is proximity detection information indicating that the proximity of the object to the input detection section is detected, the application processing section adds the information indicating the processing of the application in the processing mode to the screen of the application, and in a case that the information of the type of the event is contact detection information indicating that the contact of the object to the input detection section is detected, the application processing section processes the application depending on the processing mode.

9. An input processing method in an input processing apparatus for communicating with an information processing apparatus comprising:
distinguishing a type of an input event on the basis of coordinates of an input detected by an input detection section for detecting a proximity and a contact of an object as the input;
acquiring information of the processing mode for an application to be processed by the information processing apparatus; and
transmitting data including the information of the type of the distinguished event and the information of the acquired processing mode to the information processing apparatus.

10. An information processing method in an information processing apparatus for communicating with an input processing apparatus, comprising:
processing an application for realizing predetermined functions;
receiving data including information of a type of an event input to the input processing apparatus and information of processing mode of the application to be processed from the input processing apparatus; and
displaying a screen of the processed application via a display apparatus,
wherein in the processing process of the application, in a case that the information of the type of the event is proximity detection information indicating that a proximity of an object to the input detection section of the input processing apparatus is detected, the information indicating the processing of the application in the processing mode is added to the screen of the application, and in a case that the information of the type of the event is contact detection information indicating that a contact of the object to the input detection section of the input processing apparatus is detected, the application is processed depending on the processing mode.

11. An information processing method in an information processing system for making communication between an input processing apparatus and an information processing apparatus, comprising:
distinguishing a type of an input event on the basis of coordinates of an input detected by an input detection section for detecting a proximity and a contact of an object as the input in the input processing apparatus;
acquiring information of a processing mode for an application to be processed by the information processing apparatus in the input processing apparatus;
transmitting data including information of the type of the distinguished event and information of the acquired processing mode to the information processing apparatus in the input processing apparatus;
processing an application for realizing predetermined functions in the input processing apparatus;
receiving the data from the input processing apparatus in the input processing apparatus; and
displaying a screen of the processed application via a display apparatus in the input processing apparatus,
wherein in the processing process of the application, in a case that the information of the type of the event is proximity detection information indicating that the proximity of the object to the input detection section is detected, the information indicating the processing of the application in the processing mode is added to the screen of the application, and in a case that the information of the type of the event is contact detection information indicating that the contact of the object to the input detection section is detected, the application is processed depending on the processing mode.

12. An input processing program for causing a computer to execute the respective processes of the input processing method according to claim 9.

13. An information processing program for causing a computer to execute the respective processes of the information processing method according to claim 10.

14. An information processing program for causing a computer to execute the respective processes of the information processing method according to claim 11.
